(19) United States
(12) Patent Application Publication
(10) Pub. No.: US 2015/0344312 A1
(43) Pub. Date: Dec. 3, 2015

(54) METHOD OF MANUFACTURING GRAPHENE AND CONDUCTOR

(71) Applicant: EST Co., Ltd., Suwon-si (KR)

(72) Inventor: DEUK IL PARK, Hwaseong-si (KR)

(21) Appl. No.: 14/714,363

(22) Filed: May 18, 2015

(30) Foreign Application Priority Data
Jun. 3, 2014 (KR) 10-2014-0067885

(51) Int. Cl. C01B 31/04; H01B 1/04

(52) U.S. Cl. CPC C01B 31/0469; H01B 1/04

(57) ABSTRACT

The present invention relates to a technique for manufacturing graphene and, more particularly, to a method for manufacturing graphene and a method for manufacturing a conductor using the graphene manufacturing method, which uses the exfoliating or transferring functions of various structures having the physical properties and adhesion peculiar to graphite to manufacture graphene on a large scale and also an electrical conductor or a thermal conductor from the graphene. One aspect of the method for manufacturing graphene and the method for manufacturing a conductor using the graphene manufacturing method is that the method for manufacturing graphene includes: (a) exfoliating or transferring a graphite material onto at least one structure to form graphene particles on the surface of any one of the at least one structure; (b) releasing the graphene particles from the structure; and (c) combining the released graphene particles to form graphene. Another aspect of the method for manufacturing graphene and the method for manufacturing a conductor using the graphene manufacturing method is that the method for manufacturing graphene includes: (a) consecutively exfoliating or transferring a graphite material onto a plurality of structures to form graphene particles on the surface of any one of the plural structures; (b) releasing the graphene particles from the structure; and (c) combining the released graphene particles to form graphene.

### CROSS-REFERENCE TO RELATED APPLICATION

This application claims priority to and the benefit of Korean Patent Application No. 10-2014-0067885 filed in the Korean Intellectual Property Office on Jun. 3, 2014, the entire contents of which are incorporated herein by reference.

### BACKGROUND OF THE INVENTION

1. Field of the Invention

The present invention relates to a technique for manufacturing graphene and, more particularly, to a method for manufacturing graphene and a method for manufacturing a conductor that uses the exfoliating or transferring functions of various structures having the physical properties and adhesion peculiar to graphite to manufacture graphene on a large scale and also an electrical conductor or a thermal conductor from the graphene.

2. Related Art Technology

It is known that graphene has better electrical conductivity, thermal conductivity, and mechanical strength than such metals as copper, aluminum, etc. and exhibits optically transparent nature.

Graphene has a structure of stacking honeycomb layers. In order to maintain ideally the characteristics, it should be formed with single layer and have large area. Graphene has such good characteristics, so it is suitable for solar cells, semiconductors, nuclear fusion reactors, base material of secondary batteries, base material of clear electrodes for displays and cellphones, and it is expected that applications of graphene will be broadened.

In particular, since graphene has good electrical conductivity and transparency, it is an ideal material for transparent electrodes of display devices.

CDV (Chemical Vapor Deposition) is a general method for manufacturing large-area graphene. However, there have been difficulties in commercializing the manufacturing method because it requires high cost despite of low productivity. Nevertheless, research for applying graphene to transparent electrodes is widely progressed, because graphene manufactured by CVD is suitable for transparent electrodes of displays and cellphones which require high conductivity and visible ray transparency.

On the other hand, graphene having single layer and large area has not only good electrical conductivity but also good thermal conductivity. However, it has low thermal capacity because it is thin. Therefore, graphene is difficult to use as a heat radiator for radiating high heat.

Graphite having a graphene structure is suitably applicable to heat radiators. Graphite has a structure of stacking honeycomb layers and is abundant in nature. In recent years, graphite is widely applied to heat radiators for electrical devices. However, there are many technical difficulties in acquiring the same characteristics of graphene from the natural graphite.

Graphite must be exfoliated to be thin and large-area, in order to have characteristic of thermal radiation similar to graphene. More specifically, for the sake of using graphite as a heat radiator, it is required to make the graphite powder as thin and wide as possible and manufacture the heat radiator using the graphite powder in such a large volume as to appropriately maintain the temperature of the heat radiator.

A conventional method of manufacturing graphite powder is mechanically grinding graphite into fine powder. Another method is a chemical method that involves oxidizing graphite powder at high temperature to obtain an expanded graphite structure. However, there are technical limitations in obtaining graphite powder as thin and wide as graphene according to the mechanical grinding method or the chemical method.

Since graphite powder for heat radiator as manufactured by the mechanical grinding method depends on the particle size of the graphite, the shape of particle is generally irregular and similar to stone fragments. Generally, the graphite powder manufactured by the mechanical grinding method is used as its particle size is 40 μm or less. As such, the graphite powder mechanically ground has advantages that high density is guaranteed when it is spread or molded and that the size of particle can be controlled according to its use purpose. However, it is difficult to control the thickness of the particle, that is, the thickness of a honeycomb layer, which is stacked layer by layer. Also, the method has the advantage that proportion of pores is low owing to high density. On the other hand, the method has the disadvantage that electrical conductivity and thermal conductivity decrease with an increase in the contact resistance between powder particles.

The chemical method of manufacturing graphite powder for heat radiator using oxidation-reduction reaction has advantage in terms of high productivity. However, it has such a disadvantage that it may cause environmental pollution because it uses noxious material like sulfuric acid hazardous to human body. Further, it is difficult to produce high purity graphite because of poor manufacturing environment.

Graphite oxidized under high temperature condition by the chemical method become powder that is bulky and has very low density in the case of expansion. This powder form of graphite is used as a sheet for heat radiation of electronic devices. The expanded graphite powder of which particle size is 300 μm or less is mainly used for heat radiation purpose. The expanded graphite powder is microscopically similar to bellows in shape. Macroscopically, the expanded graphite is cotton-shaped and light-weighted. However, when the graphite powder expands in volume by the oxidization process under high temperature condition, the gaps between layers crack like bellows to generate many pores. Therefore, the particles of the expanded graphite powder are bigger and thinner than those of the graphite powder manufactured by grinding natural graphite. Thus, the expanded graphite powder has high electronic conductivity and thermal conductivity but contains many pores between particles to cause deterioration in the thermal conductivity.

In order to solve such a problem as deterioration in the characteristics of the expanded graphite powder caused by the abundance of pores, there have been applied improvement methods such as compressing the expanded graphite powder with high pressure or using the expanded graphite powder in combination with a graphite powder of small particle size or a conductive metal powder. Those methods, however, have an insignificant effect of improving the characteristics.

According to the conventional art, for the sake of making efficient heat radiators using a graphite material, it is required to exfoliate the graphite material as thin and wide as possible to secure good characteristics in terms of electrical conductivity and thermal conductivity as similar to graphene and also to adopt a method of minimizing generation of pores that greatly deteriorate electrical conductivity and thermal conductivity.

In particular, the conventional methods such as the mechanical grinding method and the chemical method have technical difficulties in obtaining a graphite powder thin and, wide like graphene and limitations in solving the problem with the abundance of pores between particles.

Currently, the application thickness of the graphite powder is normally 25 μm or greater for radiant sheets used to radiate heat from cellphones and 1 mm or greater for radiant sheets used to radiate heat from LCD TVs. In order to reduce the thickness of the radiant sheets used for those electronic devices and enhance the efficiency of heat radiation, it is necessary to make the graphite powder thin and wide and minimize the existence of pores between the particles of the graphite powder. For this purpose, there is a demand for a technique to exfoliate the graphite powder thin and wide like graphene.

### SUMMARY OF THE INVENTION

### Object of the Invention

Contrived in consideration of the problems, it is an object of the present invention to provide a method for manufacturing graphene and a method for manufacturing a conductor that solve the problems regarding insufficient exfoliation of the graphite powder and deterioration in the electrical conductivity and thermal conductivity caused by the small particle size.

It is another object of the present invention to provide a method for manufacturing graphene and a method for manufacturing a conductor that solve the problem regarding deterioration in the electrical conductivity and thermal conductivity caused by the pores existing between the particles and the environmental problem using substances harmful to the human body.

It is still another object of the present invention to provide a method for manufacturing graphene and a method for manufacturing a conductor that improve the characteristics of the graphite material, in comparison with the conventional methods such as the mechanical grinding method and the chemical method.

### Technical Solutions of the Invention

A technical feature of the method for manufacturing graphene according to the present invention which is invented to achieve the above-mentioned objects is that the method includes: (a) exfoliating or transferring a graphite material onto at least one structure to form graphene particles on the surface of any one of the at least one structure; (b) releasing the graphene particles from the structure; and (c) combining the released graphene particles to form graphene.

Preferably, the step (c) of forming graphene may include injecting an adhesive liquid for constraining the released graphene particles and then applying pressure on the released graphene particles to combine the graphene particles.

Preferably, the step (a) of forming graphene particles may include: exfoliating the graphite material onto a first structure of the plural structures to form first graphene particles on the surface of the first structure; and transferring the first graphene particles to a second structure disposed opposite to the first structure out of the plural structures to form second graphene particles.

Preferably, the step (a) of forming graphene particles may include: applying the graphite material between first and second structures making a pair out of the plural structures; exfoliating the graphite material onto the first and second structures to form first graphene particles on the surface of the first and second structures, respectively; and transferring the first graphene particles to third and fourth structures disposed opposite to the first and second structures out of the plural structures, respectively, to form second graphene particles on the surface of the third and fourth structures, respectively.

Preferably, an adhesive layer for exfoliation, transfer or release of the graphene particles may be provided on the surface of the structure.

More preferably, a rubber elastomer may be applied or mounted as the adhesive layer on the surface of the structure. The rubber elastomer may be silicone rubber.

Preferably, the method may further include applying the graphite material together with an adhesive liquid or solid onto the structure.

Preferably, the step (a) of forming graphene particles may include exfoliating or transferring the graphite material onto the surface of rollers used as the structures to form the graphene particles, the rollers being different in diameter from each other and rotating in contact with each other.

Preferably, the step (a) of forming graphene particles may include exfoliating or transferring the graphite material onto the surface of rollers and a plate used as the structures to form the graphene particles, the rollers being different in diameter from each other and rotating in contact with each other, the plate moving in a linear reciprocating motion in contact with the rollers.

Preferably, the graphite material may be used in the form of powder, plate or rod.

A technical feature of the method for manufacturing a conductor according to the present invention which is invented to achieve the above-mentioned objects is that the method includes: applying or forming the graphene manufactured by the graphene-manufacturing method on a sheet or a film to make an electrical conductor or a thermal conductor.

### Effect of the Invention

According to the present invention, some effects can be acquired as follows.

Firstly, graphene particles are manufactured by carrying out exfoliation or transfer processes in a consecutive and fast manner from a graphite material using an adhesive layer having adherence on different types of structures such as rollers, plates, etc. This can provide convenience of the manufacture and remarkably enhance the productivity.

Secondly, the method of the present invention involves exfoliation or transfer carried out in a consecutive manner, which makes it possible to obtain graphene particles extremely thin from the graphite material and further manufacture graphene powder on a thin and wide scale from the graphene particles.

Thirdly, the method of the present invention used in the manufacture of graphene enables sufficient exfoliation of the graphite material to produce graphene particles on a thin and wide scale, which makes it possible to manufacture graphene and conductors excellent in electrical conductivity and thermal conductivity.

Finally, unlike the mechanical grinding method or the chemical manufacturing method, the method of the present invention neither generate pores between the particles nor uses substances harmful to the human body, thereby causing no environmental problem while providing good characteristics of the graphene.

### BRIEF DESCRIPTION OF THE DRAWINGS

FIG. 1 is a flow chart showing the procedure of manufacturing graphene in accordance with one embodiment of the present invention.

FIG. 2 is a diagram showing an explanation of the process for manufacturing graphene in accordance with a first embodiment of the present invention, where at least one roller and a graphite powder are used to manufacture graphene.

FIG. 3 is a diagram showing an explanation of the process for manufacturing graphene in accordance with a second embodiment of the present invention, where at least one roller and a graphite powder are used to manufacture graphene.

FIG. 4 is a diagram showing an explanation of the process for manufacturing graphene in accordance with a third embodiment of the present invention, where a plurality of rollers and a graphite powder are used to manufacture graphene.

FIG. 5 is a diagram showing an explanation of the process for manufacturing graphene in accordance with a fourth embodiment of the present invention, where at least one roller and a graphite rod are used to manufacture graphene.

FIG. 6 is a diagram showing an explanation of the process for manufacturing graphene in accordance with a fifth embodiment of the present invention, where at least one roller and a graphite plate are used to manufacture graphene.

FIG. 7 is a diagram showing an explanation of the process for manufacturing graphene in accordance with a sixth embodiment of the present invention, where at least one roller and a plate structure are used to manufacture graphene.

FIG. 8 is a diagram showing an explanation of the process for manufacturing graphene in accordance with a seventh embodiment of the present invention, where at least one plate structure is used to manufacture graphene.

FIG. 9 is a diagram showing an explanation of the process for manufacturing graphene in accordance with an eighth embodiment of the present invention, where a plurality of plate structures are used to manufacture graphene.

FIG. 10 is a diagram showing an explanation of the process for manufacturing graphene in accordance with a ninth embodiment of the present invention, where at least one roller and a cylindrical structure are used to manufacture graphene.

### DETAILED DESCRIPTION OF THE INVENTION

The method to achieve the objects of the present invention can be clearly understood by referring the attached drawings along with embodiments. However, the present invention is not limited to embodiments disclosed below, but it could be embodied as various formations. These embodiments are for completing disclose of the present invention, and are also provided for the purpose of complete explanation of scope of the present invention to those who are skilled in the art. The present invention is just defined by the scope of claims. All over the specification, a reference number is used to refer to an identical element.

Hereinafter, a detailed description will be given as to a method for manufacturing graphene and a method for manufacturing a conductor according to the embodiments of the present invention with reference to the accompanying drawings.

The method for manufacturing graphene and the method for manufacturing a conductor according to the present invention are to obtain graphene particles on a thin and wide scale, a graphene powder, and a conductor including an electrical conductor or a thermal conductor from graphene, that is, to exfoliate or transfer graphite as thin and wide as possible using the weak binding force between layers peculiar to graphite.

In the present invention, an adhesive layer providing adhesion is formed on the surface (peripheral surface) of a structure taking the shape of a roller or a plate, and pressure is repeatedly applied on the graphite powder placed on the structure to exfoliate or transfer graphene particles onto the surface of the adhesive layer from the graphite material.

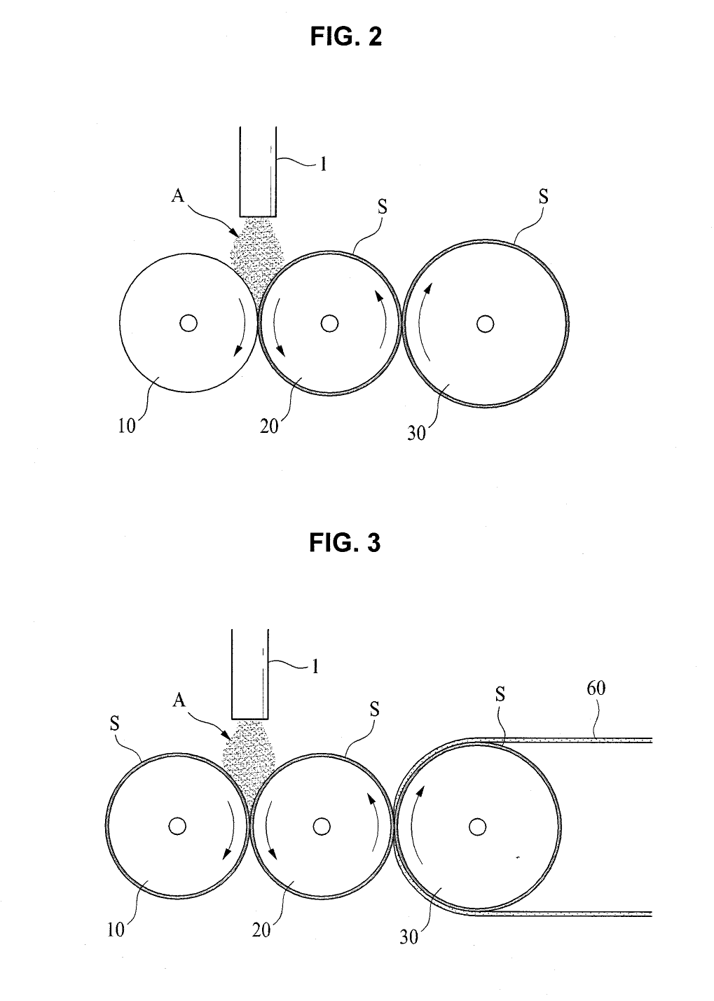

The method for manufacturing graphene and the method for manufacturing a conductor according to the present invention use various types of structures and are not specifically limited to the structures taking the shape of a roller, plate or cylinder like the examples illustrated in the following drawings, FIGS. 2 to 9. In other words, it is possible to use structures taking a variety of shapes on the surface (peripheral surface) of which an adhesive layer providing adhesion is formed to enable exfoliation or transfer of the graphite material in a consecutive and fast manner.

More specifically, the method for manufacturing graphene and the method for manufacturing a conductor according to the present invention make the use of the inherent structural characteristic of graphite that the hexagonal honeycomb lattice structure of graphite has the strong binding force between the hexagonal structures but the weak binding force between the stacking layers of graphite and thus involve applying pressure on the surface of the layers with the structure providing adhesion and then releasing the structure to exfoliate the layers of graphite and transfer them to another structure providing adhesion.

In addition, the method for manufacturing graphene according to the present invention provides a consecutive arrangement of a plurality of structures to perform exfoliation and transfer from the graphite material in a consecutive and fast manner.

Hereinafter, a description will be given as to a method for manufacturing graphene and a method for manufacturing a conductor using the manufacturing method for graphene.

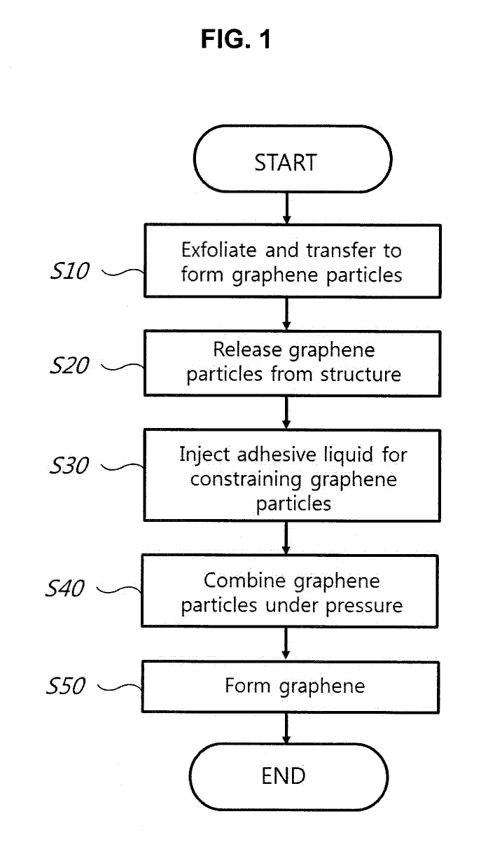

FIG. 1 is a flow chart showing the procedure of manufacturing graphene in accordance with one embodiment of the present invention.

Referring to FIG. 1, the procedure of manufacturing graphene in accordance with one embodiment of the present invention includes exfoliating or transferring a graphite material onto at least one structure to form graphene particles on the surface of any one of the at least one structures, in step S10. In this regard, a plurality of structures may be used, in which case the graphite material can be consecutively exfoliated or transferred onto the plural structures to form graphene particles on the surface of at least one of the plural structures. The graphite material and the structures may come in different forms and shapes as illustrated in FIGS. 2 to 10.

Subsequently, the graphene particles are released from the structures, in step S20.

The released graphene particles may be required to bond together, which is the case that the graphene particles are produced in the form of powder. The graphene particles in the powder form are combined to form graphene, in step S50.

To describe the procedure of forming graphene in detail, an adhesive liquid for constraining the released graphene particles together is injected into the graphene particles, in step S30.

Subsequently, pressure is applied on the graphene particles in the powder form with the adhesive liquid injected therein to combine the graphene particles, in step S40. This can form graphene particles on a thin and wide scale.

For another example, the graphite material together with an adhesive liquid may be applied to the structure, in which case pressure is imposed on the released graphene particles to combine the graphene particles without separately injecting the adhesive liquid for combining the released graphene particles.

A variety of examples for manufacturing graphene are illustrated in FIGS. 2 to 10 based on the above-described procedures of manufacturing graphene.

FIG. 2 is a diagram showing an explanation of the process for manufacturing graphene in accordance with a first embodiment of the present invention, where at least one roller and a graphite powder are used to manufacture graphene.

FIG. 3 is a diagram showing an explanation of the process for manufacturing graphene in accordance with a second embodiment of the present invention, where at least one roller and a graphite powder are used to manufacture graphene.

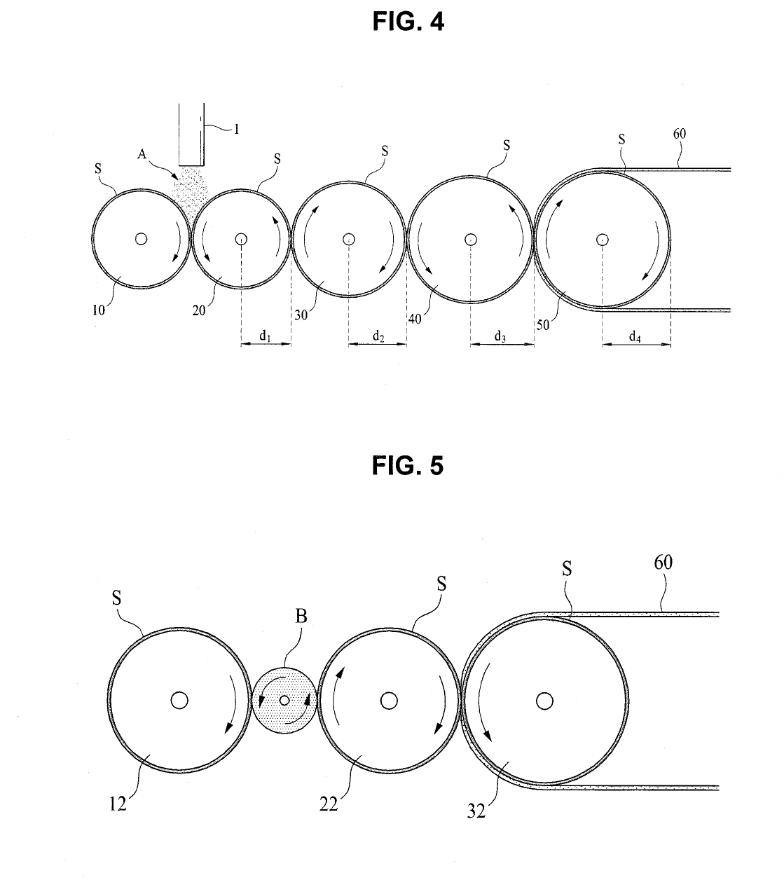

FIG. 4 is a diagram showing an explanation of the process for manufacturing graphene in accordance with a third embodiment of the present invention, where a plurality of rollers and a graphite powder are used to manufacture graphene.

Referring to FIGS. 2, 3 and 4, the process for manufacturing graphene includes at least one structure, a feeding structure for feeding a graphite material, and a releasing structure for releasing graphene particles from the surface of the structure.

At least one structure shown in FIGS. 2 and 3 includes rollers 10, 20 and 30, with the feeding structure including a feeder portion 1. A plurality of structures shown in FIG. 4 comprise a plurality of rollers 10, 20, 30, 40 and 50, with a feeder portion 1 constructed in the same manner as illustrated in FIGS. 2 and 3.

The rollers 10, 20, 30, 40 and 50 illustrated as structures in FIGS. 2, 3 and 4 are defined to include a first roller 10, a second roller 20, a third roller 30, a fourth roller 40, and a fifth roller 50.

The feeder portion 1 is for feeding a graphite material A, which may be provided in the form of powder. In particular, the feeder portion 1 may be provided to feed the graphite material A in the powder form together with an adhesive liquid or solid.

On the surface of at least one of the rollers 10, 20, 30, 40 and 50 may be formed an adhesive layer S providing adhesion.

In the example of FIG. 2, the adhesive layer S is provided on the second roller 20 out of the two rollers 10 and 20 placed at the position of feeding the graphite material and rotating in contact with each other, and also on the third roller 30 rotating in contact with the second roller 20.

As illustrated in FIGS. 3 and 4, the adhesive layer S may be provided on all the rollers 10, 20, 30, 40 and 50, including the rollers 10 and 20 rotating in contact with each other at the position of feeding the graphite material.

In other words, the adhesive layer S may be applied or mounted on the surface of at least one of the rollers 10, 20, 30, 40 and 50, as shown in FIGS. 2, 3 and 4.

The adhesive layer S may be a rubber elastomer. For example, the rubber elastomer may be silicone rubber that is a kind of adhesive rubber. The adhesive layer S may be an adhesive rubber having a low hardness and adhesion, or an adhesive liquid. In addition, adhesive layers S, each having a different intensity of adhesion, may be provided on the rollers 10, 20, 30, 40 and 50.

For the sake of manufacturing graphene according to the present invention, there may be further included a releasing portion (not shown) corresponding to a releasing structure and a graphene generator portion (not shown) for generating graphene having transparency using graphene particles released by the releasing portion (not shown).

In particular, the graphene generator portion (not shown) combines the graphene particles released by the releasing portion (not shown) to form graphene, that is, applying pressure on the graphene particles to combine the graphene particles after injection of an adhesive liquid for constraining the released graphene particles. Further, the graphene generator portion (not shown) can apply or form the generated graphene on a sheet or a film to manufacture an electrical conductor or a thermal conductor.

The above-described releasing structure can release the graphene particles from the structure using a substance having a defined pressure and a defined temperature.

In FIGS. 2, 3 and 4, the graphite material fed into the first and second rollers 10 and 20 is compressed by the rotation of the first and second rollers 10 and 20. This causes the graphene particles exfoliated from the graphite material and transferred onto the second roller 20. Subsequently, the graphene particles adhering to the surface of the second roller 20 are transferred onto the third roller 30 as the second and third rollers 20 and 30 are rotating in contact with each other.

In the example shown in FIG. 4, the graphene particles are exfoliated and transferred from the graphite material onto the second to fifth rollers 10 to 50 in a consecutive manner to form graphene particles on a thin and wide scale.

In the examples shown in FIGS. 3 and 4, as an adhesive layer S is provided on the surface of the first roller 10, the graphene particles can also be exfoliated on the surface of the first roller 10.

In this manner, FIGS. 2, 3 and 4 show that graphene can be manufactured through a structure including at least two rollers having a defined diameter, as shown in FIGS. 2, 3 and 4.

As the first to fifth rollers 10 to 50 are rotating in contact with one another, graphene particles are exfoliated from the graphite material in the form of powder and transferred onto the adhesive layer S provided on the surface of the rollers.

In order to increase the amount of graphene particles transferred onto the surface of the rollers, it is preferable to provide rollers each having a different diameter and make the transfer area wider. As the surface area of the roller increases with an increase in the diameter of the roller, the amount of the transferred graphene particles becomes greater. In other words, as shown in FIGS. 2, 3 and 4, it is preferable that the third roller 30 has the greater diameter than the second roller 20. FIG. 4 shows an example that the roller diameter increases in the order from the second roller 20 to the fifth roller 50.

For example, when the present invention uses five rollers, the five rollers each having a different diameter are arranged in a consecutive manner in the increasing order of diameter, e.g., 100 mm, 130 mm, 160 mm, 190 mm, and 210 mm to manufacture graphene.

In the method for manufacturing graphene according to the present invention, it is preferable to adjust the distance between the first and second rollers 10 and 20 in order to make the pressure applied on the graphite different depending on the size of the graphite material fed in the form of powder.

In an example of the present invention, the graphite material in the form of powder may have an average particle size of 35 μm (400 mesh), 43 μm (325 mesh), 61 μm (250 mesh), 74 μm (200 mesh), 140 μm (100 mesh), 980 μm (18 mesh), 1300 μm (14 mesh), 1900 μm (10 mesh), 2460 μm (8 mesh), 2870 μm (7 mesh), or 3350 μm (6 mesh).

When using a graphite material in the form of powder with a relatively small particle size of 35 μm, 43 μm, 61 μm, 74 μm, or 140 μm, the first and second rollers 10 and 20 are rotated in contact with each other to compress the graphite material. When using a graphite material having a relatively large particle size of 980 μm, 1300 μm, 1900 μm, 2460 μm, 2870 μm, or 3350 μm, the difference between the first and second rollers 10 and 20 can be adjusted depending on the particle size of the graphite material.

In the example of FIG. 4, when using a graphite powder having a relative small particle size of 35 to 140 μm, the amount of the graphene particles exfoliated and transferred onto the last roller, the fifth one 50, increases in amount with an increase in the particle size of 61 μm or greater. Contrarily, when the particle size is 43 μm leas than 61 μm, the amount of the graphene particles exfoliated and transferred onto the fifth roller 50 is greatly decreased than the case of using the graphite powder having a particle size of 61 μm. When the particle size is smaller as 35 μm, the amount of the graphene particles transferred onto the fifth roller 50 can be markedly decreased.

As the effects of exfoliation and transfer deteriorate when using a graphite material in the form of powder with an extremely small particle size, the present invention preferably uses a graphite material in the form of powder having a certain particle size not too small.

For example, in the case of using a graphite material in the form of powder having a relatively large particle size of 980 to 2870 μm in the present invention, it is possible to exfoliate the graphite powder and effectively transfer graphene particles onto the last fifth roller 50. However, with an increase in the particle size, the amount of the graphite powder falling down between the first and second rollers 10 and 20 due to gravity gravity increases, and the particle size of graphene transferred onto the fifth roller 50 possibly becomes irregular. On the other hand, when the amount of the graphite powder having a relatively small particle size is reduced, the amount of graphene particles falling down between the first and second rollers 10 and 20 due to gravity is significantly low, and the particle size of the graphene particles transferred onto the fifth roller 50 is relatively regular.

In the case that the particle size is 3350 μm, the graphite powder exfoliated from the first and second rollers 10 and 20 can be effectively transferred onto other rollers, such as the third roller 30, the fourth roller 40, and the fifth roller 50. But, the adhesive layer S applied or formed on the first and second rollers 10 and 20 may be damaged. Accordingly, when using a graphite material having a large particle size in the present invention, it is preferable to adjust the distance between the first and second rollers 10 and 20 longer, increase the thickness of the adhesive layer S applied or mounted on the first and second rollers 10 and 20 and provide the adhesive layer S with low hardness.

For another example, in the case of feeding a graphite material having a relatively large particle size between the first and second rollers 10 and 20, the graphite material may be fed together with an adhesive liquid or an adhesive solid like silicone.

It is preferable in the present invention to use a graphite material in the form of powder having a particle size of 3350 μm or less in consideration of the reliability.

When using rollers in the manufacture of graphene as illustrated in the examples of FIGS. 2, 3 and 4, it is possible to adjust the number, size (diameter) and rotational rate of the rollers, the thickness and hardness of the adhesive layer S applied or mounted on the rollers, the roller-to-roller distance, the pressure applied on the graphite material, etc. in consideration of the particle size of the graphite material and the desired thickness of the graphene to be obtained.

According to the embodiments of the present invention, it is preferable to use a graphite material in the form of powder with a uniform particle size as possible, ranging from 61 μm to 3350 μm.

On the other hand, as illustrated in FIGS. 2, 3 and 4, a plurality of rollers 10 to 50 may be arranged to be adjacent to one another in a consecutive manner. With this consecutive arrangement of rollers, the structures (i.e., the first and second rollers) onto which the graphite material is fed can be different from the structures (i.e., the third roller or the fifth roller) from which graphene particles are extracted, thereby enhancing the convenience of graphene production and productivity. Further, the graphene particles can be exfoliated extremely thinner as the more of rollers are used as in FIG. 4.

In the present invention, the releasing portion (not shown) is for extracting the graphene particles transferred to the adhesive layer S on the surface of the rollers providing adhesion. For making it easier to release the graphene particles by the releasing portion (not shown), the adhesive layer S applied or mounted on the surface of the rollers may be provided such that it can be easily released from the rollers.

The releasing portion (not shown) and the graphene generator portion (not shown) can operate in connection to each other to collect the graphene particles transferred and sticking to the adhesive layer S of the third roller 30 of FIGS. 2 and 3 or the fifth roller of FIG. 4. For one example, a brush or water supply equipment for providing a flow of water may be arranged to release the graphene particles.

For another example, as illustrated in FIGS. 3 and 4, a sheet (or film) 60 providing adhesion may be inserted between the rollers so that the graphene particles can be transferred onto the sheet (or film) 60, thereby directly applying the graphene particles to the sheet (or film) 60.

The graphene particles generated by the consecutive and repeated process of exfoliation and transfer in the manufacturing method of the present invention may have a shape of fish scale as different from the shape of graphene particles generated by the conventional methods such as the mechanical grinding method or the chemical method, and such a consecutive and repeated process of exfoliation and transfer of the graphene particles gradually makes the graphene particles thinner. It is therefore possible to manufacture graphene particles too thin and transparent to recognize with the naked eye.

In the examples illustrated in FIGS. 2, 3 and 4, it is possible to control the thickness of the desired graphene particles and produce graphene thin and wide on a large scale by adjusting the number, size (diameter) and rotational rate of the rollers, the thickness and hardness of the adhesive layer S applied or mounted on the rollers, the roller-to-roller distance, the pressure applied on the graphite material, etc.

FIG. 5 is a diagram showing an explanation of the process for manufacturing graphene in accordance with a fourth embodiment of the present invention, where at least one roller and a graphite rod B are used to manufacture graphene.

Unlike the examples of using a graphite material in the form of powder in FIGS. 2, 3 and 4, the example illustrated in FIG. 5 involves using a rod-shaped graphite material that serves as a roller.

The rod-shaped graphite material, that is, graphite rod B may be provided to rotate in contact with the structure. In this regard, the structure may be composed of rollers 12, 22 and 32 and exclude a feeder portion 1.

The rollers 12, 22 and 32 given as examples of the structure are defined to include a sixth roller 12, a seventh roller 22 and an eighth roller 32.

The graphite rod B is provided between the sixth and seventh rollers 12 and 22 to rotate in contact with the sixth roller 12 and the seventh roller 22 as well.

On the surface of at least one of the sixth, seventh and eighth rollers 12, 22 and 32 may be formed an adhesive layer S providing adhesion. In the example of FIG. 5, the adhesive layer S is applied or mounted on all the rollers, that is, the sixth, seventh and eighth rollers 12, 22 and 32.

The adhesive layer S is the same as described in reference to FIGS. 2, 3 and 4 and may not be further described in detail. Also, the releasing portion (not shown) and the graphene generator portion (not shown) may not be described in detail for the same reason.

In the manufacture of graphene through the structure of FIG. 5, the sixth and seventh rollers 12 and 22 rotate in contact with the graphite rod B provided between them and apply a defined pressure on the graphite rod B to have the graphite rod B in a rotary motion, so the graphite rod B is exfoliated into graphene particles on the surface of the sixth and seventh rollers 12 and 22. Subsequently, the graphene particles adhering to the surface of the seventh roller 22 are transferred onto the eighth roller 32 as the seventh and eighth rollers 22 and 32 are rotating in contact with each other.

In the example of FIG. 5, the adhesive layer S is provided on the surface of the sixth and seventh rollers 12 and 22, so the graphene particles can be exfoliated on the surface of the sixth and seventh rollers 12 and 22 at the same time. Accordingly, a transfer structure using the rotations of the seventh and eighth rollers 22 and 32 may be additionally provided at any location with the graphite rod B positioned at the center.

In order to increase the amount of the transferred graphene particles, the eighth roller 32 may have a larger diameter than the seventh roller 22.

Also in the example of FIG. 5, a sheet (or film) 60 providing adhesion may be inserted between the seventh and eighth rollers 22 and 32, so the graphene particles can be transferred directly onto the sheet (or film) 60.

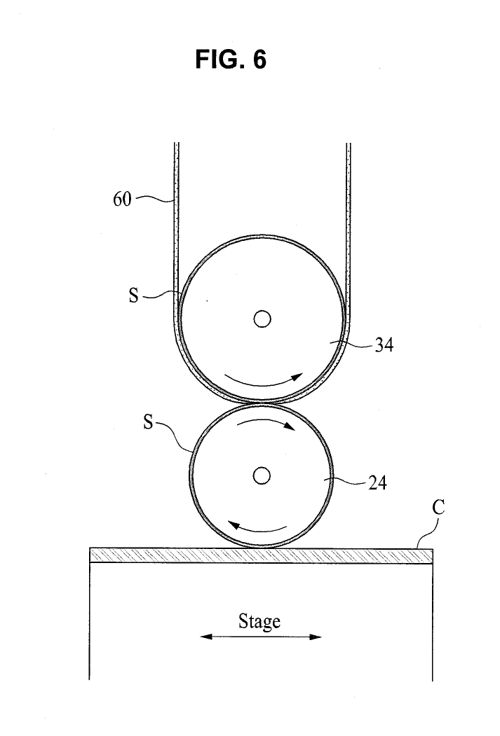

FIG. 6 is a diagram showing an explanation of the process for manufacturing graphene in accordance with a fifth embodiment of the present invention, where at least one roller and a graphite plate C are used to manufacture graphene.

Unlike the examples of using a graphite material in the form of powder in FIGS. 2, 3 and 4 or a graphite rod placed between the rollers in FIG. 5, the example illustrated in FIG. 5 involves using a graphite plate C to make graphene.

The plate-shaped graphite material, that is, graphite plate C may be provided to make a linear reciprocating motion in contact with the structure and thereby rotate the structure. In this regard, the structure may be composed of rollers 24 and 34 and exclude a feeder portion 1.

The rollers 24 and 34 given as examples of the structure are defined to include a ninth roller 24 and a tenth roller 34.

The graphite plate C is provided on the top of a stage to make a linear reciprocating motion in contact with the ninth roller 24 according to the drive of the stage. With this, the ninth roller 24 rotates by the linear reciprocating motion of the graphite plate C, and the tenth roller 34 gets to rotate in contact with the ninth roller 24.

On the surface of the ninth and tenth rollers 24 and 34 may be formed an adhesive layer S providing adhesion. In the example of FIG. 6, the adhesive layer S is applied or mounted on the ninth and tenth rollers 24 and 34 to make graphene.

The adhesive layer S is the same as described in reference to FIGS. 2, 3 and 4 and may not be further described in detail. Also, the releasing portion (not shown) and the graphene generator portion (not shown) may not be described in detail for the same reason.

In the example of FIG. 6, the graphite plate C applies a defined pressure on the ninth roller 24 in contact with the ninth roller 24 to have the ninth roller 24 in a rotary motion, so graphene particles are exfoliated from the graphite plate C onto the ninth roller 24. Subsequently, the graphene particles adhering to the surface of the ninth roller 24 are transferred onto the tenth roller 34 as the ninth roller 24 is rotating in contact with the tenth roller 34.

In order to increase the amount of the transferred graphene particles, the tenth roller 34 may have a larger diameter than the ninth roller 24.

Also in the example of FIG. 6, a sheet (or film) 60 providing adhesion may be inserted between the ninth and tenth rollers 24 and 34, so the graphene particles can be transferred directly onto the sheet (or film) 60.

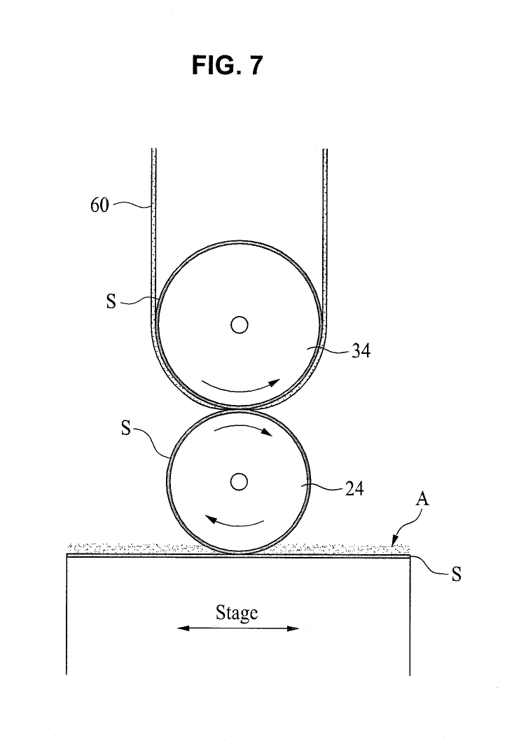

FIG. 7 is a diagram showing an explanation of the process for manufacturing graphene in accordance with a sixth embodiment of the present invention, where at least one roller and a plate structure are used to manufacture graphene.

The example of FIG. 7 is similar to that of FIG. 6, excepting that a graphite material in the form of powder is fed to the top of a stage instead of using a graphite plate C. Accordingly, a feeder portion 1 may be included in the example of FIG. 7.

The graphite material in the form of powder, that is, graphite powder A is fed to the top of a stage, which then makes a linear reciprocating motion in contact with the ninth roller 24. With this, the ninth roller 24 rotates by the linear reciprocating motion of the stage, and the tenth roller 34 gets to rotate in contact with the ninth roller 24.

On the surface of the stage with the graphite powder A may be formed an adhesive layer S providing adhesion. The adhesive layer S may also be provided on the surface of the ninth and tenth rollers 24 and 34.

The procedures in the example of FIG. 7 are the same as described in the example of FIG. 6.

In the examples of FIGS. 6 and 7, it has been described that the linear reciprocating motion of the stage drives exfoliation and transfer of the graphene particles onto the rollers 24 and 34. It may also be possible to rotate the ninth roller 24 together with the tenth roller 34 and move it from the top of the stage while the stage is fixed, thereby exfoliating and transferring the graphene particles.

In the examples of FIGS. 6 and 7, the distance between the stage and the ninth roller 24 is preferably adjusted so as to facilitate the exfoliation and transfer of the graphene particles.

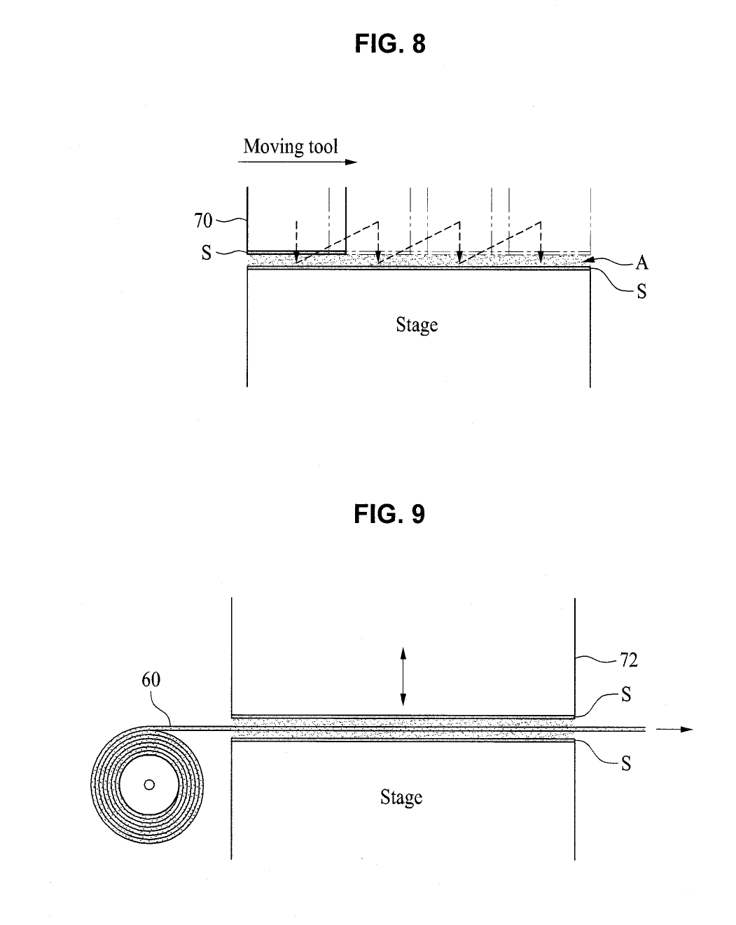

FIG. 8 is a diagram showing an explanation of the process for manufacturing graphene in accordance with a seventh embodiment of the present invention, where at least one plate structure is used to manufacture graphene.

Like the example of FIG. 7, the example of FIG uses a graphite material in the form of powder fed to the top of a stage. Rather than using the rotations of rollers to exfoliate and transfer graphene particles, the example of FIG. 7 involves exfoliation of graphene particles using a moving tool 70 that makes an up-and-down motion while moving on the top of the stage at regular intervals, with the graphite material in the form of powder fed to the top of the fixed stage.

On the top of the stage may be formed an adhesive layer S providing adhesion, and the graphite powder A is fed to the top of the adhesive layer S.

The adhesive layer S providing adhesion is formed on the bottom of the moving tool 70 that faces the stage.

The moving tool 70 moves at regular intervals on the top of the stage with the graphite powder A fed on and makes an up-and-down motion to repeatedly apply pressure on the graphite powder A on the top of the stage. With this, graphene particles can be exfoliated from the graphite powder A on the surface of the adhesive layer S applied or mounted on the moving tool 70.

FIG. 9 is a diagram showing an explanation of the process for manufacturing graphene in accordance with an eighth embodiment of the present invention, where a plurality of plate structures are used to manufacture graphene.

Like the examples of FIGS. 7 and 8, the example of FIG. 9 involves feeding a graphite material in the form of powder to the top of the stage. But, the exfoliation and transfer of graphene particles are not achieved by the rotary motion of the rollers but by the up-and-down motion of a moving tool 72 arranged in opposite to the stage on the top of the stage after the graphite material in the form of powder is fed to the top of the stage.

In particular, the example of FIG. 9 involves inserting a sheet (or film) 60 providing adhesion between the stage and the moving tool 72 and moving it forward to exfoliate and transfer graphene particles directly onto the sheet (or film) 60. An adhesive layer S providing adhesion may be formed on the top of the stage and on the bottom of the moving tool 72 facing the stage.

The moving tool 72 makes an up-and-down motion on the top of the stage with the graphite powder A on, to repeatedly apply pressure on the graphite powder A on the top of the stage. This can exfoliate graphene particles from the graphite powder A on the adhesive layer S applied or mounted on the moving tool 72.

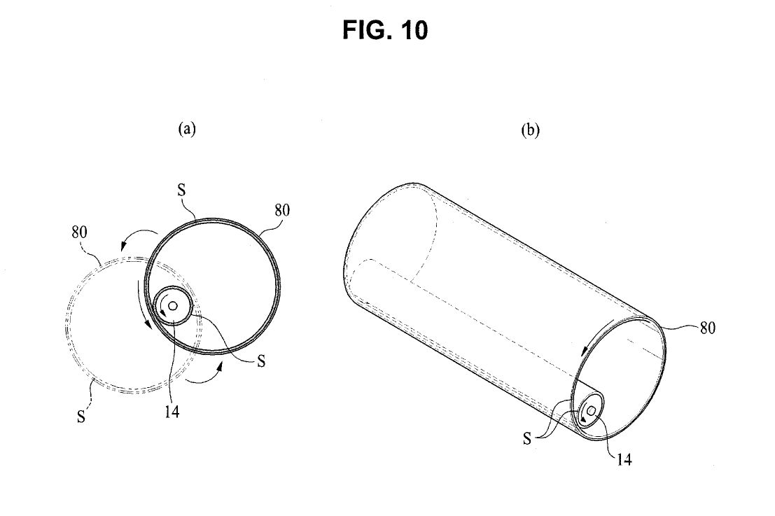

FIG. 10 is a diagram showing an explanation of the process for manufacturing graphene in accordance with a ninth embodiment of the present invention, where at least one roller and a cylindrical structure are used to manufacture graphene.

The example of FIG. 10 involves feeding a graphite material in the form of powder into a cylindrical structure 80 and rotating the cylindrical structure 80 along the surface of a roller 14 provided in the cylindrical structure 80 to exfoliate the graphite material.

In particular, the example of FIG. 10 may have an adhesive layer S providing adhesion on the inner surface of the cylindrical structure 80 and on the surface of the roller 14 in the cylindrical structure 80.

As the cylindrical structure 80 rotates along the surface of the inner roller 14 and thus applies pressure on the graphite powder A, the graphite powder A is exfoliated to give graphene particles on the adhesive layer S applied or mounted on the inner surface of the cylindrical structure 80 and on the surface of the roller 14.

In the examples that use a graphite material in the form of powder out of the examples of FIGS. 2 to 10, the graphite material to exfoliate preferably has a uniform particle size.

Further, the adhesive layer S provided in the examples of FIGS. 2 to 10 may be a low-hardness adhesive rubber providing adhesion or an adhesive liquid.

In the examples of FIGS. 2 to 10, the thickness of the adhesive layer S may be all the same. But, when using a graphite material in the form of powder, the thickness of the adhesive layer S may vary depending on the particle size of the graphite material.

In the case of using a silicone rubber as the adhesive layer S and a graphite powder having a large particle size, it is desirable to use a silicone rubber having a thickness of 5 mm and a hardness (Shore A) of 30 in order to prevent the silicone rubber damaged by the corner of the graphite powder and overcome the difference in the pressure applied to the graphite powder caused by the difference in the particle size and the difference in the contact area between the graphite powder and the surface of the roller. In other words, the present invention is enabled to determine the thickness and hardness of the adhesive layer S differently depending on the particle size of the graphite powder to exfoliate.

As for the structures including the rollers, the plate or the cylinder as provided in the examples of FIGS. 2 to 10, it is also preferable to adjust the distance from the contact positions between the structures in consideration of the particle size of the graphite powder to exfoliate or the shape of the graphite material such as a graphite rod or plate.

In an additional example of the present invention, the manufacture of graphene according to the present invention may involve using a container having an adhesive layer S providing adhesion on the inner surface and a spherical structure having an adhesive layer S providing adhesion on the outer surface to perform exfoliation or transfer of graphene particles from a graphite powder. In other words, the spherical structure having an adhesive layer S on the surface makes a motion in different directions in the container fed with the graphite powder, so graphene particles can be exfoliated or transferred from the graphite powder. Preferably, the container makes a rotary motion in order to secure the motion of the spherical structure.

Though the embodiments of the present invention are explained as above with reference to the attached drawings, the present invention is not limited to the above-explained embodiments, but could be embodied with various formations. Also, it can be understood that those skilled in the art can carry out the present invention with detailed formation, without altering the technical matter or essential feature of the present invention. Therefore, the embodiments disclosed above must be understood as examples and not be limited to the embodiments themselves.

1. A method for manufacturing graphene, comprising:
(a) exfoliating or transferring a graphite material onto at least one structure to form graphene particles on the surface of any one of the at least one structure;
(b) releasing the graphene particles from the structure; and
(c) combining the released graphene particles to form graphene.

2. The method as claimed in claim 1, wherein the step (c) of forming graphene comprises injecting an adhesive liquid for constraining the released graphene particles and then applying pressure on the released graphene particles to combine the graphene particles.

3. The method as claimed in claim 1, wherein the step (a) of forming graphene particles comprises:
exfoliating the graphite material onto a first structure of plural structures to form first graphene particles on the surface of the first structure; and
transferring the first graphene particles onto a second structure disposed opposite to the first structure out of the plural structures to form second graphene particles.

4. The method as claimed in claim 1, wherein the step (a) of forming graphene particles comprises:
applying the graphite material between first and second structures making a pair out of plural structures;
exfoliating the graphite material onto the first and second structures to form first graphene particles on the surface of the first and second structures, respectively; and
transferring the first graphene particles onto third and fourth structures disposed opposite to the first and second structures out of the plural structures, respectively, to form second graphene particles on the surface of the third and fourth structures, respectively.

5. The method as claimed in claim 1, wherein an adhesive layer for exfoliation, transfer or release of the graphene particles is provided on the surface of the structure.

6. The method as claimed in claim 5, wherein a rubber elastomer is applied or mounted as the adhesive layer onto the surface of the structure.

7. The method as claimed in claim 6, wherein the rubber elastomer is silicone rubber.

8. The method as claimed in claim 1, further comprising:
applying the graphite material together with an adhesive liquid or solid onto the structure.

9. The method as claimed in claim 1, wherein the step (a) of forming graphene particles comprises exfoliating or transferring the graphite material onto the surface of rollers used as the structures to form the graphene particles, the rollers being different in diameter from each other and rotating in contact with each other.

10. The method as claimed in claim 1, wherein the step (a) of forming graphene particles comprises exfoliating or transferring the graphite material onto the surface of rollers and a plate used as the structures to form the graphene particles, the rollers being different in diameter from each other and rotating in contact with each other, the plate moving in a linear reciprocating motion in contact with the rollers.

11. The method as claimed in claim 1, wherein the graphite material is used in the form of powder, plate or rod.
